(19) United States
(12) Patent Application Publication
(10) Pub. No.: US 2013/0191705 A1
(43) Pub. Date: Jul. 25, 2013

(54) SEMICONDUCTOR STORAGE DEVICE

(71) Applicants: Kouji Watanabe, Tokyo (JP); Toshikatsu Hida, Kanagawa (JP); Takashi Oshima, Chiba (JP)

(72) Inventors: Kouji Watanabe, Tokyo (JP); Toshikatsu Hida, Kanagawa (JP); Takashi Oshima, Chiba (JP)

(73) Assignee: Kabushiki Kaisha Toshiba, Tokyo (JP)

(21) Appl. No.: 13/824,542

(22) PCT Filed: Dec. 15, 2011
(86) PCT No.: PCT/JP2011/079756

§ 371 Date: Mar. 18, 2013

(30) Foreign Application Priority Data
Dec. 15, 2010 (JP) 2010-279505

(51) Int. Cl. G06F 11/10

(52) U.S. Cl. CPC G06F 11/1068
USPC 714/773

(57) ABSTRACT

According to an embodiment, a semiconductor storage device includes an error correction processing unit that executes encoding process related data to be dispersedly written over a plurality of memory areas and decoding process related data dispersedly written over the plurality of memory areas. A transfer management unit determines whether or not data related to the data transfer request is a target of the error correction process and causes the error correction processing unit to execute the error correction process only with respect to the data determined as the target of the error correction process.

### CROSS-REFERENCE TO RELATED APPLICATIONS

This application is based upon and claims the benefit of priority from Japanese Patent Application No. 2010-279505, filed on Dec. 15, 2010; the entire contents of which are incorporated herein by reference.

### FIELD

Embodiments described herein relate generally to a semiconductor storage device including a non-volatile semiconductor memory.

### BACKGROUND

In a semiconductor storage device using a plurality of semiconductor storage chips as memory chips, even with employing an error correcting code (ECC) for repairing the failure of a memory cell, the memory chips cannot be perfectly free from the failure. Accordingly, there is a concern that that failure is consequently likely to lead to the failure of the semiconductor storage device.

### BRIEF DESCRIPTION OF THE DRAWINGS

FIG. 1 is a diagram illustrating an internal configuration example of an SSD serving as a semiconductor storage device.

FIG. 2 is a diagram illustrating an internal configuration example of a NAND I/F.

FIG. 3 is a diagram for explaining an encoding process of an inter-channel ECC process.

FIG. 4 is a diagram for explaining a decoding process of the inter-channel ECC process.

FIG. 5 is a diagram illustrating a configuration example of a management table.

FIG. 6 is a diagram illustrating an aspect of foggy/fine writing.

FIG. 7 is a flowchart illustrating an operation process according to a first embodiment.

FIG. 8 is a diagram illustrating data transfer control.

FIG. 9 is a flowchart illustrating the decoding process of the inter-channel ECC process.

FIG. 10 is a flowchart illustrating an operation process according to a second embodiment.

FIG. 11 is a perspective view illustrating the outward appearance of a personal computer.

FIG. 12 is a diagram illustrating a functional configuration example of the personal computer.

### DETAILED DESCRIPTION

In general, according to an embodiment, a semiconductor storage device includes a non-volatile semiconductor memory including a plurality of memory areas which can be independently operated respectively, a plurality of memory interfaces that execute data access to the plurality of memory areas and output data transfer requests, and a temporary memory buffer that temporarily stores data. A control unit controls the plurality of memory interfaces such that data is dispersedly written over the plurality of memory areas. A transfer management unit manages the data transfer order between the temporary memory buffer and the plurality of memory interfaces based on the contents of the data transfer requests from the plurality of memory interfaces. An error correction processing unit that executes encoding process related data to be dispersedly written over the plurality of memory areas and decoding process related data dispersedly written over the plurality of memory areas, using data that is being transferred between the temporary memory buffer and the plurality of memory interfaces. The transfer management unit determines whether or not data related to the data transfer request is a target of the error correction process and causes the error correction processing unit to execute the error correction process only with respect to the data determined as the target of the error correction process.

Exemplary embodiments of a semiconductor storage device will be explained below in detail with reference to the accompanying drawings. The present invention is not limited to the following embodiments.

A solid state drive (SSD), which is provided with a non-volatile semiconductor memory such as a NAND flash memory (hereinafter, referred to as simply “NAND memory”), is attracting public attention as a memory system used in a computer system. Most of the SSDs include a temporary memory buffer, and when data required from a host device is written in the NAND memory, the SSD temporarily stores data input from the host device in the temporary memory buffer and then writes data read from the temporary memory buffer in the NAND memory.

Meanwhile, in a system such as the SSD including a large number of memory chips, even when the chip defect rate of a NAND memory is not problematic on one chip, a defect rate of the system may not be ignorable. For this reason, inter-channel (cross) error correction for repairing a chip defect is considered. In the inter-channel error correction, an ECC is calculated based on data that is dispersedly recorded in a plurality of memory chips. In the case of calculating the ECC, the SSD calculates the ECC using code source data stored in the temporary memory buffer. When the calculation is finished, the calculated ECC and the code source data are written in the NAND memory.

For this reason, it is considered that in a first cycle, the ECC is calculated using the code source data stored in the temporary memory buffer, and then in a second cycle, the ECC and the code source data are transferred to the memory chip. However, in this technique, data transfer and code calculation are performed using a total of two cycles. That is, since access to the temporary memory buffer is performed for code calculation as well as writing to the memory chip, the band width of the temporary memory buffer is reduced, whereby the throughput is lowered.

Further, when a cyclic code such as a Reed-Solomon (RS) code is used in the inter-channel error correction, encoding (which may be hereinafter referred to as “encoding process”) and decoding (which may be hereinafter referred to as “decoding process”) need have the same data input order. However, the data input order does not necessarily match with an order that allows writing to and reading from a plurality of NAND memories to be performed at the highest speed. Further, when the data input order is followed at all times, the system performance may possibly be lower than the case in which the inter-channel correction is not performed.

Thus, in the present embodiment, the following control is performed:

(a) A inter-channel error correction circuit performs an inter-channel error correcting process (encoding/decoding) using data that is being transferred between the temporary memory buffer and the NAND memory;

(b) The need of the inter-channel error correcting process is determined, and when it is determined that the inter-channel error correcting process is not necessary, the inter-channel error correcting process is not performed; and

(c) In the case of the inter-channel error correcting process in which the data input order needs to be followed, data transfer is performed between the temporary memory buffer and the NAND memory in the data input order regardless of a NAND memory side request.

Hereinafter, exemplary embodiments of a semiconductor storage device will be described in detail with reference to the accompanying drawings. The present invention is not limited to the following embodiments.

### First Embodiment

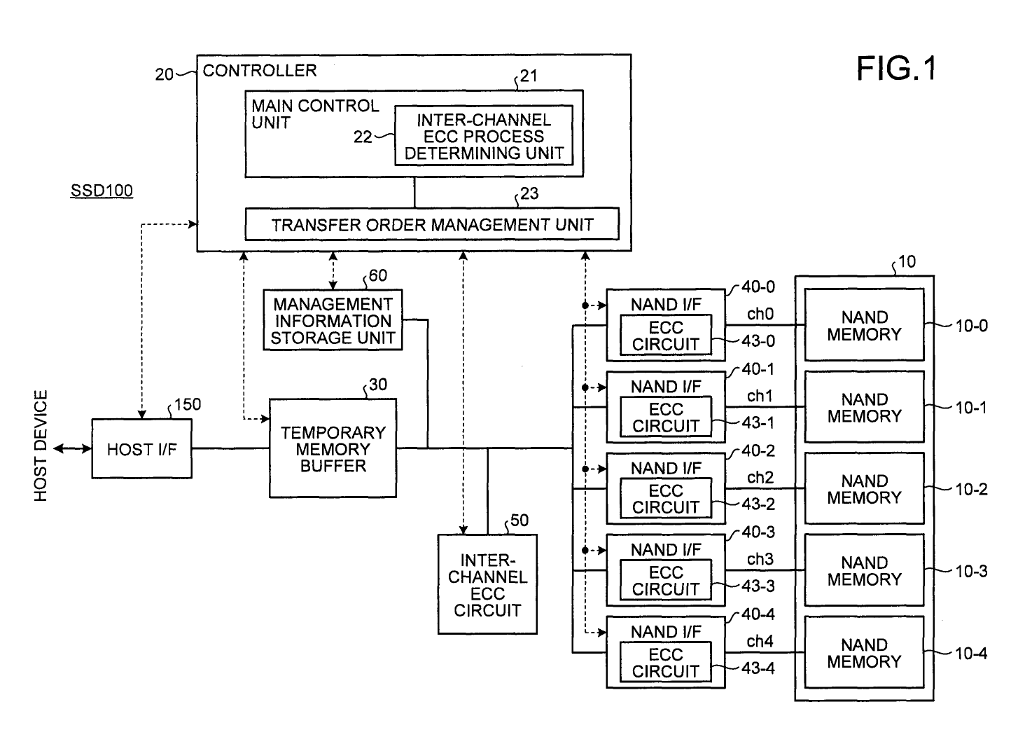

FIG. 1 is a block diagram illustrating the configuration of a semiconductor storage device according to an embodiment. Here, an SSD 100 is described as an example of the semiconductor storage device, but an application of the present embodiment is not limited to the SSD. For example, the present embodiment can be applied to a semiconductor memory that stores data in a non-volatile manner or an auxiliary storage device such as a memory card provided with a controller. In FIG. 1, a data line is indicated by a solid line, and a control line is indicated by a dashed line.

Further, in each embodiment, functional blocks may be implemented by hardware, software, or a combination thereof. Therefore, a description will be made below from a functional point of view so that the functional blocks can become apparent even by any of the three implementations. Whether the functions are implemented by hardware or software depends on a concrete embodiment or a design constraint imposed on the entire system. Those skilled in the art can implement these functions by various methods in each concrete embodiment, and deciding such an implementation is also included in the scope of the invention.

The SSD 100 is connected to a host device such as a personal computer (PC) by a host interface (host I/F) 150 and functions as an external storage device of the host device. The SSD 100 includes the host I/F 150, NAND memories 10 (10-0 to 10-4), which are non-volatile semiconductor memories storing data read from the host device or data to be written in the host device, a controller 20 that performs various kinds of controls related to data transfer control between the SSD 100 and the host device, a temporary memory buffer 30 that is used for the controller 20 to primarily store transfer data for data transfer and includes a volatile memory such as a dynamic random access memory (DRAM), NAND interfaces (NAND I/Fs) 40 (40-0 to 40-4), which control the data transfer between the NAND memories 10-0 to 10-4 and the temporary memory buffer 30, an inter-channel ECC circuit 50 that performs an inter-channel ECC process (error correction encoding/decoding) on data which is dispersedly stored in the plurality of NAND memories 10-0 to 10-4, and a management information storage unit 60 that stores various kinds of management information such as a correspondence relation of logical block addressing (LBA) that is a logical address designated by the host device, a data storage location on the NAND memory 10, and a storage location of a code generated by an inter-channel correction encoding process on the NAND memory 10.

Data transmitted from the host device is first stored in the temporary memory buffer 30 through the host I/F 150 under the control of the controller 20. Thereafter, the data is read from the temporary memory buffer 30 and then written in the NAND memory 10 through the NAND I/F 40. Data read from the NAND memory 10 is first stored in the temporary memory buffer 30 through the NAND I/F 40. Thereafter, the data is read from the temporary memory buffer 30 and transferred to the host device through the host I/F 150.

The NAND memory 10 stores user data designated by the host or stores the management information managed by the management information storage unit 60 for backup. The NAND memory 10 includes a memory cell array in which a plurality of memory cells are arranged in a matrix form, and each of the memory cells can perform multi-value storage using an upper page and a lower page. In this embodiment, for convenience, it is assumed that each of the NAND memories 10-0 to 10-4 is configured with one memory chip. Each memory chip is configured such that a plurality of physical blocks that are data erasing units are arranged. In the NAND memory 10, writing of data or reading of data is performed in units of physical pages. The physical block is configured with a plurality of physical pages. Data or redundant information (inter-channel ECC code) is written in the NAND memories 10-0 to 10-4 in ascending order of pages based on the physical storage locations of the NAND memories 10-0 to 10-4 regardless of the logical address (LBA).

In the present embodiment, the number of NAND memories 10 is 5. One channel (one of ch0 to ch4) is allocated to each of the NAND memories 10-0 to 10-4. One (ch4) of the channels is allocated as a channel for writing the redundant information generated by the inter-channel ECC circuit 50, and the remaining channels (ch0 to ch3) are allocated as channels for writing data that is requested to be written from the host device. The ECC is configured with a set of pages of the channels ch0 to ch4. That is, the NAND memories 10-0 to 10-3 are used for data storage, and the NAND memory 10-4 is used for ECC storage. It is assumed that a set of physical blocks of the channels ch0 to ch4 configuring the ECC is referred to as a logical block. The NAND memories 10-0 to 10-4 are connected to the NAND I/Fs 40-0 to 40-4 through the channels ch0 to ch4, respectively. The NAND memories 10-0 to 10-4 can perform a parallel operation independently.

The host I/F 150 includes a communication interface, for example, confirming to an advanced technology attachment (ATA) standard and controls communication between the SSD 100 and the host device under the control of the controller 20. The host I/F 150 receives a command transmitted from the host device and transmits the command (a write command) to the controller 20 when writing of data whose logical address (LBA) is designated by the command is requested. At this time, when the size of the data requested to be written is equal to or less than the page size, the data is transmitted to the temporary memory buffer 30. However, when the size of the data is greater than the page size, the data is divided in units of pages, and the divided data (referred to as “divided data”) is transmitted to the temporary memory buffer 30 because the translation between a logical address and a physical address is performed in units of pages in this embodiment.

The temporary memory buffer 30 is used as a temporary memory unit for data transfer. That is, the temporary memory buffer 30 is used to temporarily store data which is requested to be written by the host device before it is written in the NAND memory 10 or is used to read data which is requested to be read from the NAND memory 10 by the host device 10 and temporarily to store the data. The temporary memory buffer 30 is configured with a volatile memory such as a DRAM or an SRAM.

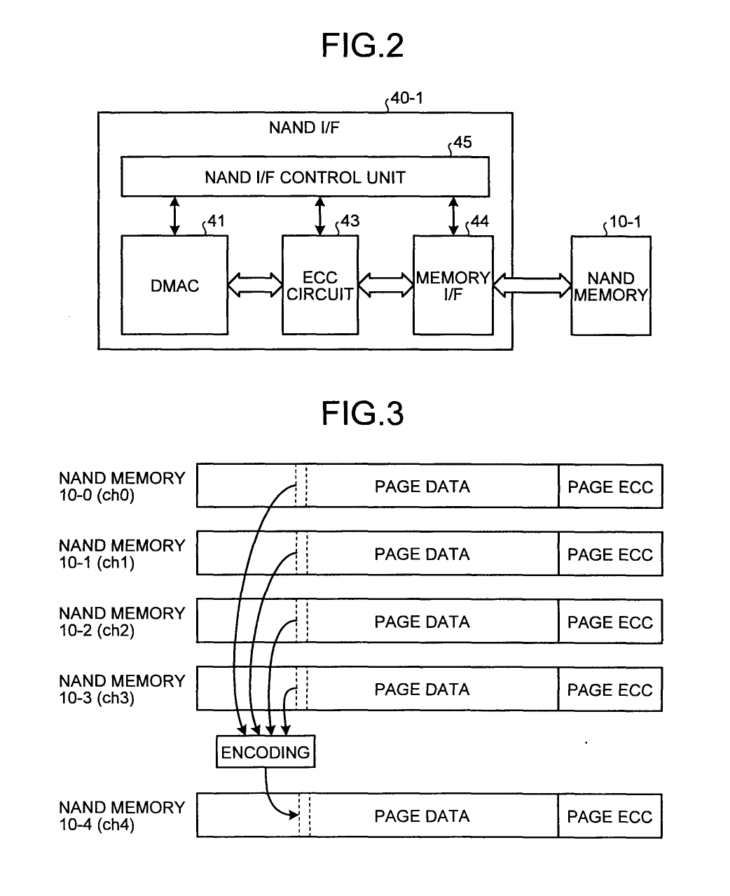

The NAND I/Fs 40-0 to 40-4 control the data transfer between the NAND memories 10-0 to 10-4 and the temporary memory buffer 30. FIG. 2 illustrates an exemplary internal configuration of the NAND I/F. In order to allow the NAND I/Fs 40-0 to 40-4 to independently operate the channels, a direct memory access (DMA) controller (DMAC) 41, an error correction circuit (ECC circuit) 43, a memory I/F 44, and a NAND I/F control unit 45 are provided for each channel. The DMA controller 41 controls the data transfer between the temporary memory buffer 30 and the ECC circuit 43 according to an DMA system under the control of the NAND I/F control unit 45.

The ECC circuit 43 performs an encoding process of the ECC process (the error correcting process) on data transferred from the DMA controller 41 according to the control by the NAND I/F control unit 45, adds an encoding result to the data, and outputs the resultant data. Further, the ECC circuit 43 performs a decoding process of the ECC process (the error correcting process using the ECC) on data read from the NAND memory 10 through the memory I/F 44 according to the control of the NAND I/F control unit 45 and outputs the error-corrected data to the DMA controller 41. The memory I/F 44 outputs the data including the ECC code, output from the ECC circuit 43, to the NAND memory 10 and outputs data including the ECC code, input from the NAND memory 10, to the ECC circuit 43.

The ECC circuit 43 generates an error detecting code (EDC) (for example, a cyclic redundancy check (CRC) code) and the ECC (for example, a Hamming code), for example, for each data having a size corresponding to a page size and adds the generated codes to writing target data. The data including the EDC and the ECC code is written in the NAND memory 10 through the memory I/F 44. Further, when data is read from the NAND memory 10, the ECC circuit 43 performs the error correction on data of the page size read from the NAND memory 10 using the ECC code and then detects whether or not erroneous correction has occurred using the EDC.

When it is determined that the erroneous correction has occurred, that is, when the erroneous correction has been caused by an error exceeding the correcting capability of the ECC code, the ECC circuit 43 notifies the controller 20 of the occurrence of the erroneous correction through the NAND I/F control unit 45. When the erroneous correction notice is received from the ECC circuit 43, the controller 20 reads the data including data of the page size corresponding to the error location and the redundant information from the plurality of NAND memories 10-0 to 10-4 again and then performs the inter-channel ECC process on the read data through the inter-channel ECC circuit 50. The ECC process performed by the ECC circuit 43 inside the NAND I/F controllers 40-0 to 40-4 is hereinafter referred to as a page ECC to be discriminated from the inter-channel ECC process.

The NAND I/F control unit 45 converts a command received from a main control unit 21 of the controller 20 into a NAND I/F command and controls the DMA controller 41, the ECC circuit 43, and the memory I/F 44 according to the converted command. Further, the NAND I/F control unit 45 manages an operation state (an operating state, a standby state, or the like) of the NAND memory 10 connected to its own channel. When a process on a previous command received from the controller 20 has not been finished, the NAND I/F control unit 45 outputs a data transfer request corresponding to a current command to the transfer order management unit 23 of the controller 20 at a point in time when the process on the previous command is finished. Here, the command notified from the main control unit 21 of the controller 20 includes inter-channel ECC on/off information Eflag representing whether or not the inter-channel ECC circuit 50 needs to perform the inter-channel ECC process in response to the command. When the command is output to the transfer order management unit 23 of the controller 20, the NAND I/F control unit 45 adds the inter-channel ECC on/off information Eflag to the command and outputs the resultant data.

The NAND I/F control units 45 of the NAND I/Fs 40-0 to 40-4 causes data of page units read from the NAND memories 10-0 to 10-4 of a channel correspondence to be transferred to the temporary memory buffer 30 according to an execution permission received from the transfer order management unit 23 of the controller 20.

The inter-channel ECC circuit 50 executes the error correction encoding process or the error correction decoding process using data that is being transferred, while there is a snoop on data that is being transferred, at the time of the data transfer between the temporary memory buffer 30 and the NAND I/F 40. The inter-channel ECC circuit 50 usually performs the error correction encoding process when data is transferred from the temporary memory buffer 30 to the NAND I/F 40 or when an execution request is notified from the transfer order management unit 23 of the controller 20. When the execution request is not notified from the transfer order management unit 23 of the controller 20, the inter-channel ECC circuit 50 does not perform the error correction encoding process.

An example of the error correction encoding process is illustrated in FIG. 3. In the error correction encoding process, the ECC is generated using data which is dispersedly stored in the plurality of NAND memories 10-0 to 10-3 which can independently operate, that is, data that is dispersedly stored in a plurality of memory chips. In FIG. 3, the inter-channel ECC circuit 50 calculates the ECC, for example, by bytes at locations having the same offset, with respect to each data of the page size that is to be written in the channels ch0 to ch3. The calculation result is transferred from the inter-channel ECC circuit 50 to the NAND I/F 40-4 of channel ch4 as the redundant information and then written at the locations having the same offset of the NAND memory 10-4 through the NAND I/F 40-4 of channel ch4. That is, in the channels ch0 to ch4, the ECC is configured with bytes at the locations having the same offset inside the page.

In the case of the error correction encoding, one physical block may be selected from each of the channels ch0 to ch3, one page may be selected from each of the selected physical blocks, and the ECC may be calculated, for example, from the bytes (the same column) at the locations having the same offset of the selected pages. Alternatively, a plurality of physical blocks may be selected from each of the channels ch0 to ch3, one page may be selected from each of the selected physical blocks, and the ECC may be calculated, for example, from the bytes (the same column) at the locations having the same offset of the selected pages.

In addition, in the inter-channel ECC circuit 50, the error correction decoding process is typically performed when data is transferred from the NAND I/F 40 to the temporary memory buffer 30 and when an execution request from the transfer order management unit 23 of the controller 20 is notified. When the execution request from the transfer order management unit 23 of the controller 20 is not notified, the error correction decoding process is not performed.

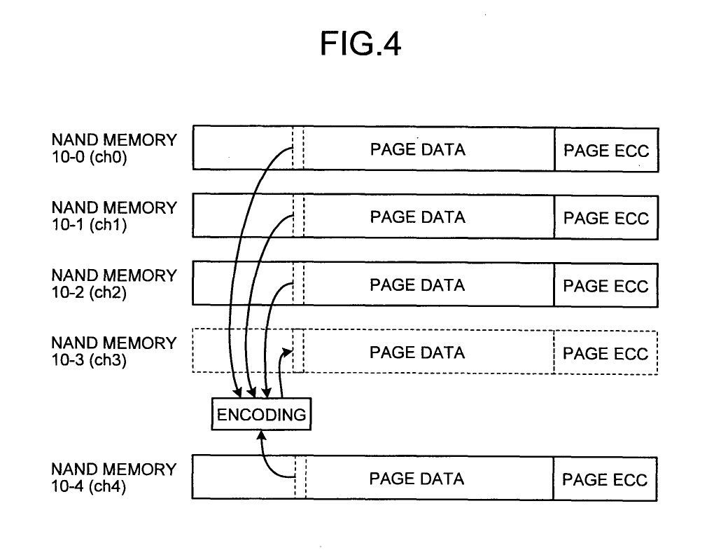

An example of the error correction decoding process is illustrated in FIG. 4. FIG. 4 is a diagram illustrating an aspect of recovering data having a defect caused by the failure occurring in the NAND memory 10-3 of channel ch3. In the recovery aspect illustrated in FIG. 4, parity is used as an encoding system. Specifically, the data is read which is associated with the same ECC as data having an uncorrectable defect and which is written in the NAND memories of the channels other than the channel corresponding to the data having the uncorrectable defect and the redundant information (here, data written in the channels ch0, ch1, and ch2 and the redundant information written in the channel ch4). Then, the inter-channel ECC circuit 50 recovers the data of the channel ch3 using byte data having the same offset in the data and the redundant information. by the way, when an Reed-Solomon (RS) code or a Bose-Chaudhuri-Hocqenghem (BCH) code is used as an encoding system, data of the channel in which an error has occurred is recovered using data of all channels including data of the channel in which an uncorrectable defect has occurred and a redundant code.

In the case of reading from the NAND memory 10, encoding may be performed by the inter-channel ECC circuit 50. For example, let us assume that data A, B, C, and D are written in the NAND memories 10-0 to 10-3, and a code E is stored in the NAND memory 10-4. In this state, when the data A is updated to data A′ by the host device, it is necessary to calculate the code E again using the data A′ written by the host device and the data B, C, and D present in the NAND memories 10-1 to 10-3. In this case, a new code E′ is calculated by calculating a code of the data A′ through the error ECC circuit 50 when data is transferred from the temporary memory buffer 30 to the NAND I/F and then calculating codes of the data B, C, and D through the inter-channel ECC circuit 50 when the data B, C, and D read from the NAND memories 10-1 to 10-3 are transferred from the NAND I/Fs.

In the first embodiment, the inter-channel ECC circuit 50 employs an error correction coding system in which data needs to be input to the ECC circuit 43 at the time of decoding in the same order as at the time of encoding like the cyclic code such as the RS code or the BCH code. The inter-channel ECC circuit 50 performs encoding using data that is being transferred between the temporary memory buffer 30 and the NAND I/Fs 40-0 to 40-4. For this reason, at the time of encoding, the controller 20 stores a transfer order of encoding target data to be transferred from the temporary memory buffer 30 to the NAND I/Fs 40-0 to 40-4 in the management information storage unit 60, and at the time of decoding, the controller 20 transfers data from the NAND I/Fs 40-0 to 40-4 to the temporary memory buffer 30 in the stored order.

That is, since the transfer order of the encoding target data becomes the encoding order of the inter-channel ECC circuit 50, in the case of the cyclic code, decoding needs to be performed in the encoding order at the time of decoding, and data transfer at the time of decoding is performed in the data transfer order at the time of encoding. Further, when it is necessary to manage the encoding order, the data transfer order from the temporary memory buffer 30 to the NAND I/Fs 40-0 to 40-4 at the time of encoding may be decided in advance, and data transfer between the temporary memory buffer 30 and the NAND I/Fs 40-0 to 40-4 may be performed in the decided order.

On the other hand, when encoding such as parity (exclusive OR) that detects an error location (an error channel) based on an error correction result of the page ECC process by the ECC circuits 43-0 to 43-3 of the NAND I/Fs 40-0 to 40-3 and performs error correction decoding based on the detection result is employed as the error correction coding system employed by the inter-channel ECC circuit 50, data does not need be input to the inter-channel ECC circuit 50 at the time of decoding in the same order as at the time of encoding. A process when the inter-channel ECC circuit 50 employs the error correcting code will be described in a second embodiment.

The management information storage unit 60 is used to store various kinds of management information including data-code management information for managing a correspondence of a storage location of data (code source data) stored in the NAND memory 10, a storage location of an inter-channel ECC (redundant information) corresponding to the data, and a logical address (LBA) designated by the host device. The management information is backed up to the NAND memory 10. The data-code management information may have an arbitrary configuration to the extent that a correspondence relation between the logical address (LBA) and the storage location of the NAND memory at which the code is stored, a correspondence relation between the code source data and the inter-channel ECC, and storage positions of the code source data and the inter-channel ECC in the NAND memory can be defined. In addition, the management information storage unit 60 also stores ECC process order management information Eseq for managing the data transfer order between the temporary memory buffer 30 and the NAND I/Fs 40-0 to 40-4 when the above-mentioned inter-channel ECC process is performed, that is, the ECC processing order of the inter-channel ECC circuit 50. The management information storage unit 60 is managed by the controller 20.

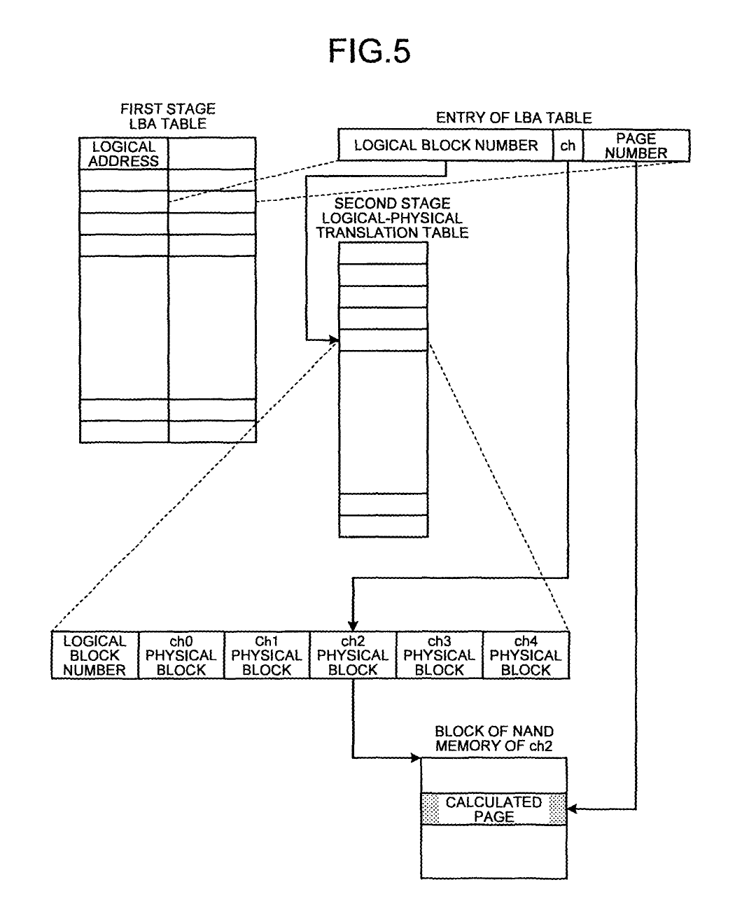

FIG. 5 is a diagram illustrating an example of a management table for managing the data-code management information. The data-code management table includes an LBA table and a logical-physical translation table. The entry of the LBA table uses a logical address (LBA) as an index and includes a channel number, a page number assigned to a page, and a logical block number assigned to the logical block storing the data.

The logical block number refers to identification information for associating the code source data with the inter-channel ECC (redundant information). Here, the channel number is represented by ch0 to ch4 and represents a channel connected to the NAND memory 10 including the physical block storing data corresponding to the LBA. The page number represents a page, which stores data corresponding to the LBA, in the physical block specified by the logical block number and the channel number.

The logical-physical translation table stores the logical block number and physical blocks of channels associated with the logical block in a corresponding manner. The logical-physical translation table uses the logical block number as an index and stores the address (physical block address) of the physical block of each channel associated with the logical block. In this configuration, the logical block number stored in the entry of the LBA table corresponding to a specific logical address is used as an index, and the entry of the logical-physical translation table related to the logical block is specified by the index. Then, the physical block of the NAND memory 10 connected to the channel having the channel number recorded in the entry of the LBA table is specified from among the physical blocks stored in the entry of the logical-physical translation table. Then, a page in which data corresponding to the logical address is written is specified by the page number included in the entry of the LBA table.

As described above, data that is requested to be written by the host device is written on a page basis in each of the pages of the channels ch0 to ch3, and the redundant information added to configure the inter-channel ECC is written in the channel ch4. Therefore, the redundant information is written in a storage area of the physical address of the channel ch4 registered in each entry of the logical-physical translation table.

The controller 20 includes the main control unit 21 and a transfer order management unit 23. The main control unit 21 is a processor that reads a system program stored in the NAND memory 10 to a main memory unit (not shown) and executes the system program. The main control unit 21 implements various kinds of management functions by executing the system program. The main control unit 21 controls writing of data to the NAND memory 10 or reading of data from the NAND memory 10 by interpreting the command transmitted from the host device through the host I/F 150 and controlling components such as the host I/F 150, the temporary memory buffer 30, the inter-channel ECC circuit 50, and the NAND I/Fs 40-0 to 40-4 according to the interpreted command. Further, when an organizing of the NAND memory 10, data flash from the temporary memory buffer 30, or the like is needed, the main control unit 21 generates a corresponding command and controls the temporary memory buffer 30, the inter-channel ECC circuit 50, the NAND I/Fs 40-0 to 40-4, and the like.

As described above, in the present embodiment, when data that is requested to be written by the host device has the size larger than the page size, the data is divided into two or more in units of pages, and the divided data of the page units are dispersedly written in the channels ch0 to ch3. Further, when data that is requested to be read by the host device has the size larger than the page size, the data is divided into two or more, and the divided data of the page units are read from the NAND memory 10 and transferred to the temporary memory buffer 30. Various kinds of managements on the page division are performed by the main control unit 21.

Further, the main control unit 21 includes an inter-channel ECC process determining unit 22 that determines whether or not the commands output to the NAND I/Fs 40-0 to 40-4 is a target of an execution of the ECC process. As described above, when a command is output to the NAND I/Fs 40-0 to 40-4, the inter-channel ECC process determining unit 22 adds the inter-channel ECC on/off information Eflag representing whether or not the inter-channel ECC process needs to be performed. An example of a case in which the inter-channel ECC process determining unit 22 turns on the inter-channel ECC on/off information Eflag will be described below.

(1) The inter-channel ECC process is not performed when the host device requests reading. Eflag is turned off.

(2) The inter-channel ECC process (encoding) is performed when the host device requests writing. Eflag is turned on.

(3) The inter-channel ECC process is not performed when the data transfer from the NAND memory 10 to the temporary memory buffer 30 is performed at the time of data organizing of the NAND memory 10. Eflag is turned off.

(4) When the host device requests reading or when the data transfer from the NAND memory 10 to the temporary memory buffer 30 is performed at the time of data organizing, if it is determined that it is difficult to correct an error through the page ECC process, data is read from the NAND memory 10 again, and the inter-channel ECC process (decoding) is performed using the read data. Eflag is turned on.

(5) When the same data needs to be input to the NAND memory 10 twice or more in order to form a desired threshold value distribution corresponding to data that is requested to be written by the host device, the inter-channel ECC process (encoding) is performed at the time of the data transfer related to any one of data inputs of twice or more, and the inter-channel ECC process (encoding) is not performed at the time of the data transfer related to the remainder. Eflag is turned on/off.

Next, a description will be made in connection with the data organizing of the NAND memory 10. The NAND memory 10 frequently employs the following writing system. In this writing system, a block needs to be erased before writing. In the NAND memory 10, erasing is performed in units of blocks, and writing is performed on the erased block in units of pages. That is, in the NAND memory 10, writing can be sequentially performed on pages on which writing has not been performed among the erased blocks, and it is difficult to perform overwriting on a page on which writing has been already performed.

When the logical address (LBA) designated by a data write request is designated again and writing of new data (data update) is requested by the host device, the SSD 100 writes the new data in a page on which writing has not been performed in the erased block yet. At this time, a page in which previous writing has been performed corresponding to the logical address is invalidated, and a page in which the new data has been written is validated. Further, at this time, the SSD 100 writes the new data and the redundant information while configuring the above-mentioned inter-channel correction code.

The management information storage unit 60 includes a table that manages a valid page and an invalid page on the physical blocks of the channels ch0 to ch4 associated with the logical blocks, but a detailed description of the table is not provided.

In the NAND memory 10, when the number of invalid pages increases by continuous writing, the capacity to write is reduced. There is a reduction in the number of newly erased blocks on which writing can be performed, that is, the number of blocks (referred to as “free blocks”) on which writing is not yet performed after erasing, and thus it is difficult to perform writing at a point in time when the security of the free block is not assured.

In order to prevent this, the SSD 100 performs the data organizing (for example, compaction) of the NAND memory 10 at appropriate timing. In the compaction, valid data is collected and rewritten in another block. A block including only invalid data is erased, and a new free block is generated. At the time of compaction, data of the NAND memory 10 is first read out to the temporary memory buffer 30 and then rewritten in another block of the NAND memory 10.

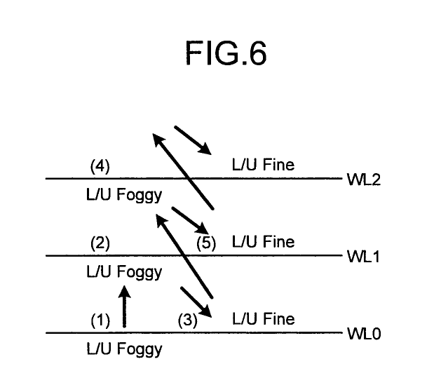

Next, a writing system needing data inputs of multiple times will be described with reference to FIG. 6. As the writing system needing data inputs of multiple times, for example, there is a system in which, in order to prevent a threshold value from varying in a multi-value memory cell with the writing to an adjacent memory cell, writing is performed on an adjacent memory cell by performing writing rougher than a target threshold value, and thereafter writing is performed equally to the target threshold value (hereinafter, this writing system is referred to as “foggy/fine writing system”). This writing system is disclosed in detail, for example, in U.S. patent application Ser. No. 12/504,966.

(1) First, data corresponding to a total of two pages of a lower page and a upper page is input to the NAND memory 10, and the data is foggily (roughly) written in a lower page and an upper page of a word line 0 (WL0).

(2) Next, data corresponding to a total of two pages of a lower page and an upper page is input to the NAND memory 10, and the data is foggily (roughly) written to a lower page and an upper page of a word line 1 (WL1).

(3) Next, the same data as the data corresponding to a total of two pages input in (1) is input, and the data is finely written in the lower page and the upper page of the word line 0 (WL0).

(4) Next, data corresponding to a total of two pages of a lower page and a upper page is input to the NAND memory 10, and the data is foggily (roughly) written in a lower page and an upper page of a word line 2 (WL2).

(5) Next, the same data as the data corresponding to a total of two pages input in (2) is input, and the data is finely written in the lower page and the upper page of the word line 1 (WL1). Thereafter, the rest is the same as above.

As described above, when the foggy/fine writing system is employed, since a writing process is performed on the same page twice, data needs to be input to the same page twice. The number of times that data is input is not limited to twice, and a writing order on each page is not limited thereto.

The transfer order management unit 23 decides an execution order of a plurality of data transfer requests with the inter-channel ECC on/off information Eflag input from the NAND I/Fs 40-0 to 40-4 and outputs an execution permission to the NAND I/Fs 40-0 to 40-4 in an order according to the decided execution order. An example of a method of deciding the execution order will be described below. In the following deciding method, the main control unit 21 of the controller 20 manages an encoding request and a decoding request not to be mixed in the data transfer request notified from the NAND I/Fs 40-0 to 40-4.

(a) When all of the data transfer requests notified from the NAND I/Fs 40-0 to 40-4 are targets of the inter-channel ECC process (Eflag=on), the execution order of the data transfer requests is decided depending on an encoding/decoding order regardless of the notice order of the data transfer requests notified (input) from the NAND I/Fs 40-0 to 40-4.

(b) Let us assume that a data transfer request that is a target of the inter-channel ECC process target (Eflag=on) and a data transfer request that is not a target of the inter-channel ECC process target (Eflag=off) are mixed in the data transfer requests notified from the NAND I/Fs 40-0 to 40-4. In this case, when the data transfer requests notified from the NAND I/Fs 40-0 to 40-4 are not the targets of the inter-channel ECC process, execution is immediately made. However, when the data transfer requests are the targets of the inter-channel ECC process, it is determined whether or not the execution order matches with the encoding/decoding order. When the execution order matches with the encoding/decoding order, execution is immediately made. However, when the execution order does not match with the encoding/decoding order, the process proceeds to determination on the data transfer request from the next NAND I/F.

(c) When all of the data transfer requests notified from the NAND I/Fs 40-0 to 40-4 are not the targets of the inter-channel ECC process (Eflag=off), the data transfer is executed when the NAND I/F determining the transfer order is decided.

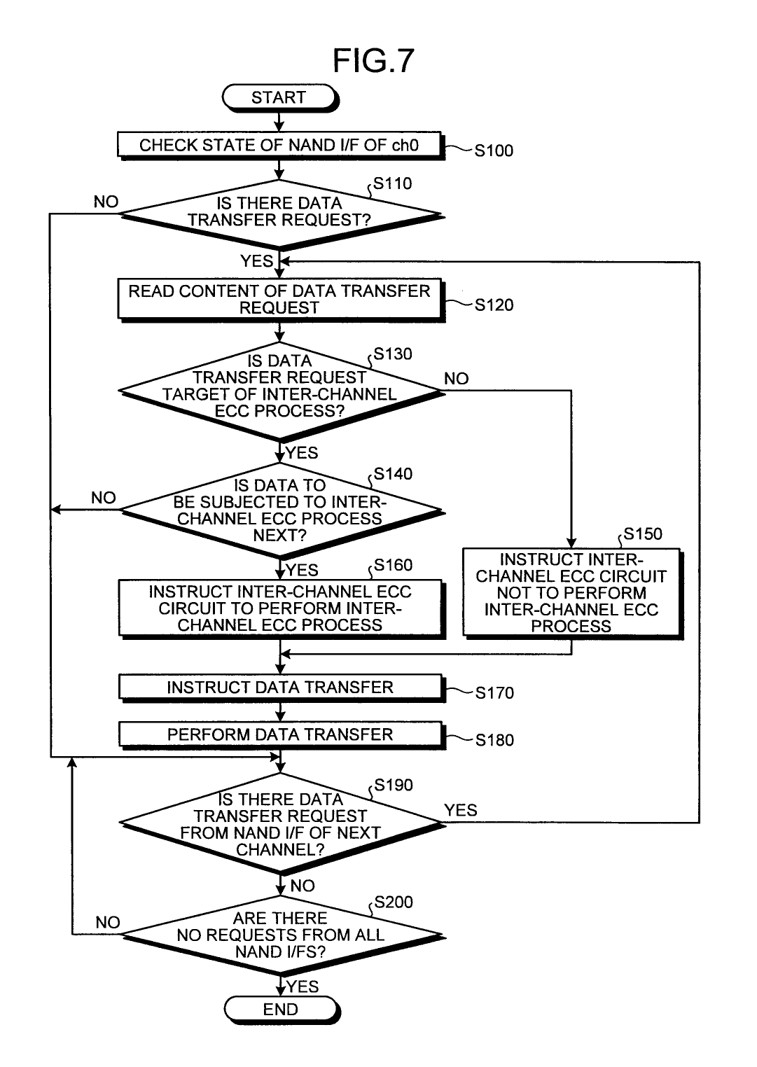

Next, a processing procedure performed by the transfer order management unit 23 will be described with reference to a flowchart illustrated in FIG. 7. In this case, the transfer order management unit 23 decides which NAND I/F 40 determines whether or not the data transfer is to be perform in a round-robin fashion. In this case, it is assumed that a round-robin order is NAND I/F 40-0→NAND I/F 40-1→NAND I/F 40-2→NAND I/F 40-3→NAND I/F 40-0→ . . . .

First, the transfer order management unit 23 determines whether or not there is a data transfer request from the NAND I/F 40-0 of the channel ch0 (steps S100 and S110). When there is no data transfer request, the process proceeds to step S190. When there is the data transfer request, the content of the data transfer request is read (step S120), and it is determined whether or not the data transfer request is the target of the inter-channel ECC process, based on the inter-channel ECC on/off information Eflag added to the data transfer request in the content that is read (step S130).

When it is determined in step S130 that the data transfer request is not the target of the inter-channel ECC process, the transfer order management unit 23 instructs the inter-channel ECC circuit 50 not to perform the inter-channel ECC process (step S150) and notifies the NAND I/F 40-0 of an execution permission for the data transfer (step S170). Thus, the NAND I/F 40-0 executes the data transfer between the NAND I/F 40-0 and the temporary memory buffer 30 without performing the inter-channel ECC process (step S180). After the data transfer ends, the transfer order management unit 23 determines whether or not there is a data transfer request from the next NAND I/F 40-1 decided in the round-robin fashion (step S190).

Meanwhile, when it is determined in step S130 that the current data transfer request is the target of the inter-channel ECC process, the transfer order management unit 23 determines whether or not the inter-channel ECC process to be performed by the data transfer request is data that causes the inter-channel ECC process to be performed later, based on the content of the data transfer request read in step S120. That is, when the data transfer accompanying the inter-channel ECC process is performed immediately in response to the data transfer request, the transfer order management unit 23 determines whether or not the ECC process order is correct using the ECC process order management information Eseq stored in the management information storage unit 60 (step S140). When it is determined that the current data transfer request follows the ECC process order, the transfer order management unit 23 outputs an inter-channel ECC process execution instruction including identification information representing encoding or decoding to the inter-channel ECC circuit 50 (step S160). Further, the transfer order management unit 23 notifies the NAND I/F 40-0 of the data transfer execution permission (step S170). Thus, the NAND I/F 40-0 executes the data transfer between the NAND I/F 40-0 and the temporary memory buffer 30 while performing the inter-channel ECC process (step S180).

However, when it is determined in step S140 that the current data transfer request does not follow the ECC process order, the transfer order management unit 23 skips the current data transfer request from the NAND I/F 40-0 and determines whether or not there is a data transfer request from the next NAND I/F 40-1 decided in the round-robin fashion (step S190).

The transfer order management unit 23 determines whether or not there is a data transfer request from the next NAND I/F 40-1 (step S190). When there is a data transfer request from the NAND I/F 40-1, the data transfer request from the NAND I/F 40-1 is dealt with by executing the processes of steps S120 to S180 in the aforementioned way. However, when there is no data transfer request from the NAND I/F 40-1, it is determined whether or not there are no requests from all of the NAND I/Fs (step S200). When there are requests from other NAND I/F, the aforementioned process is executed on the data transfer requests from the NAND I/Fs 40-2 and 40-3. When the process on the data transfer request from the NAND I/F 40-3 is finished, the aforementioned process is executed on the NAND I/F 40-0 again. In this way, when there are no data transfer requests from all of the NAND I/Fs 40, the transfer order management unit 23 finishes the process.

The main control unit 21 manages whether or not the transfer of all data configuring one inter-channel ECC is finished based on the report from the transfer order management unit 23 and notifies the inter-channel ECC circuit 50 of the transfer request of the redundant information (an encoding result/a decoding result) including a transfer direction at a point in time when the transfer of all data configuring one inter-channel ECC is finished. The transfer direction refers to information identifying whether the transfer is the transfer from the inter-channel ECC circuit 50 to the temporarily buffer 30 or the transfer from the inter-channel ECC circuit 50 to the NAND I/F 40. The inter-channel ECC circuit 50 having received the notice transfers the inter-channel ECC process result to the NAND I/F 40-4 or the temporary memory buffer 30 according to the designated transfer direction.

For example, in the case of the write request requested from the host device, after the transfer (the temporary memory buffer 30→the NAND I/Fs 40-0 to 40-3) of all data configuring one inter-channel ECC is finished, the encoding result is transferred from the inter-channel ECC circuit 50 to the NAND I/F 40-4. Then, the NAND I/F 40-4 writes the encoding result transferred from the inter-channel ECC circuit 50 at a storage location on the NAND memory 10-4 that is designated by a command from the main control unit 21.

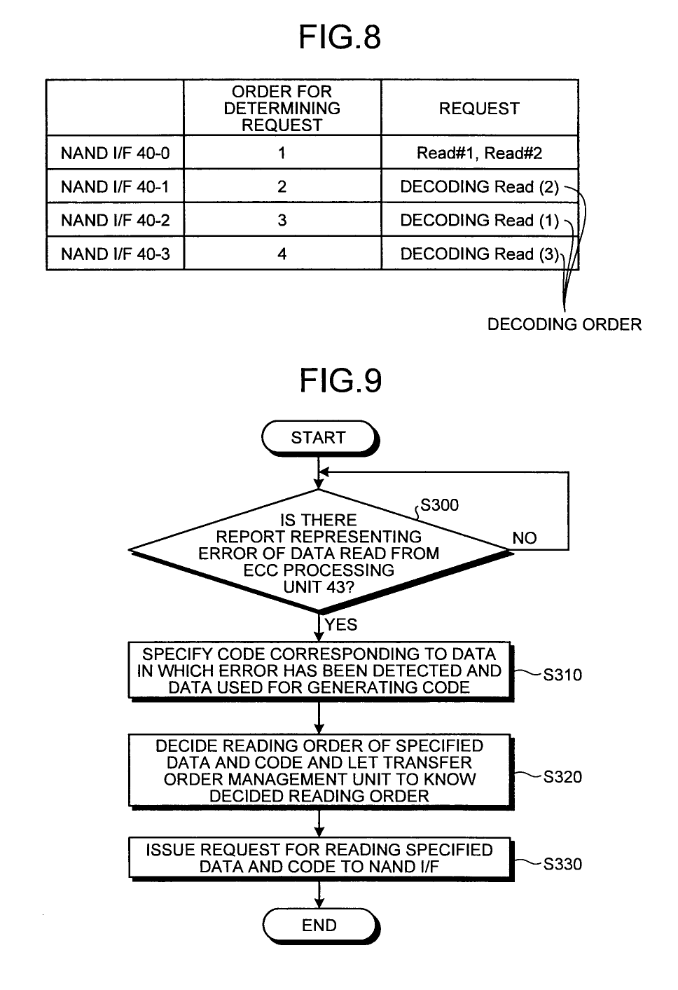

Next, a concrete example will be described with reference to FIG. 8. For example, let us assume that two read requests (Read#1 and Read#2) not accompanying the inter-channel ECC process are received from the NAND I/F 40-0, one read request accompanying the inter-channel ECC process is received from the NAND I/F 40-1, one read request accompanying the inter-channel ECC process is received from the NAND I/F 40-2, and one read request accompanying the inter-channel ECC process is received from the NAND I/F 40-3 as illustrated in FIG. 8. In this case, it is assumed that the inter-channel ECC process needs to be performed in a described order of the NAND I/F 40-2, the NAND I/F 40-1, and the NAND I/F 40-3 as illustrated in FIG. 8.

Initially, the data transfer request (Read#1) of the NAND I/F 40-0 is determined. Since the data transfer request does not accompany the inter-channel ECC process, the data transfer request (Read#1) of the NAND I/F 40-0 is immediately executed. Next, the data transfer request (decoding Read) of the NAND I/F 40-1 is determined. The data transfer request does not follow the decoding order and thus is skipped. Next, the data transfer request (decoding Read) of the NAND I/F 40-2 is determined. Since the data transfer request follows the decoding order, the data transfer request of the NAND I/F 40-2 is immediately executed. Then, the data transfer request (decoding Read) of the NAND I/F 40-3 is determined. The data transfer request does not follow the decoding order and thus is skipped.

Next, the data transfer request (Read#2) of the NAND I/F 40-0 is determined. Since the data transfer request does not accompany the inter-channel ECC process, the data transfer (Read#2) of the NAND I/F 40-0 is immediately executed. Next, the data transfer request (decoding Read) of the NAND I/F 40-1 is determined. Since the data transfer request follows the decoding order, the data transfer request of the NAND I/F 40-1 is immediately executed. Next, the data transfer request of the NAND I/F 40-1 is determined. Since there is no data transfer request, it is skipped to the next. Then, the data transfer request (decoding Read) of the NAND I/F 40-3 is determined. Since the data transfer request follows the decoding order, the data transfer request of the NAND I/F 40-3 is immediately executed.

Next, an operation process when it is difficult to correct an error in the page ECC performed by the main control unit 21 will be described with reference to a flowchart illustrated in FIG. 9. When a report representing that it is difficult to correct an error (the occurrence of the above mentioned erroneous correction) is received from the ECC circuit 43 of any one of the NAND I/Fs 40-0 to 40-3 (Yes in step S300), the main control unit 21 specifies both an inter-channel ECC corresponding to the data from which an error is detected, and code source data used to generate the code based on the data-code management information of FIG. 5 stored in the management information storage unit 60 (step S310).

Further, the main control unit 21 decides an order for reading out the specified code source data and the specified inter-channel ECC based on the ECC process order management information Eseq stored in the management information storage unit 60 and lets the transfer order management unit 23 to know the determination result (step S320). The main control unit 21 notifies the NAND I/F 40 of a read request command for reading the specified code source data and the specified inter-channel error correcting code (step S330).

Thus, after the transfer (the NAND I/Fs 40-0 to 40-3→the temporary memory buffer 30) of all code source data configuring the specified inter-channel ECC is finished, the data transfer of the inter-channel ECC from the NAND I/F 40-4 to the inter-channel ECC circuit 50 is performed, and then the decoding result is transferred from the inter-channel ECC circuit 50 to the temporary memory buffer 30.

As described above, according to the first embodiment, the inter-channel ECC process is executed using data that is being transferred between the temporary memory buffer 30 and the NAND I/F 40, and it is determined whether or not the inter-channel ECC process is necessary. When the inter-channel ECC process is not necessary, the inter-channel ECC process is skipped, and the data transfer between the temporary memory buffer 30 and the NAND I/F 40 is further executed according to the inter-channel ECC process order regardless of the request of the NAND I/F 40 side. Therefore, the throughput and the system performance can be improved without reducing the band width of the temporary memory buffer.

In the above embodiment, the transfer order management unit 23 has a function of determining the data transfer requests from the NAND I/Fs 40 in an order decided in a round-robin fashion. However, the transfer order management unit 23 may have a function of determining the contents of the data transfer requests from the NAND I/Fs 40 in an order in which the data transfer requests are input from the NAND I/Fs 40. Based on the determination result, the execution permission of the data transfer is given to the NAND I/Fs 40, and the ECC process is controlled by the inter-channel ECC circuit 50.

Further, based on the content of the data transfer request from the NAND I/F 40, the transfer order management unit 23 may determine whether or not the ECC process is to be executed by the data transfer request and whether encoding or decoding is to be executed. Then, when it is determined that the ECC process is to be executed and encoding is to be executed, the data transfer is immediately executed by executing the inter-channel ECC process by the inter-channel ECC circuit 50, and an order of the encoded data is recorded as the ECC process order management information Eseq. Further, when it is determined that the ECC process is to be executed and decoding is to be executed, it is determined whether or not the decoding order is being followed based on the ECC process order management information Eseq recorded at the time of encoding. When the decoding order is being followed, the data transfer is immediately executed by executing the inter-channel ECC process by the inter-channel ECC circuit 50. However, when the decoding order is not being followed, the data transfer is skipped, and the data transfer request from another NAND I/F 40 is determined.

### Second Embodiment

In a second embodiment, a system having no restriction to an encoding/decoding order like a parity (an exclusive OR) is used as the error correction coding system employed by the inter-channel ECC circuit 50. When the parity is employed, an error location (an error channel) is detected based on the error correction result of the page ECC process by each of the ECC circuits 43-0 to 43-3 of the NAND I/Fs 40-0 to 40-3, and error correction decoding is performed based on the detection result. That is, as illustrated in FIG. 4, decoding is performed using codes and data of other channels excluding a channel in which it is difficult to correct an error.

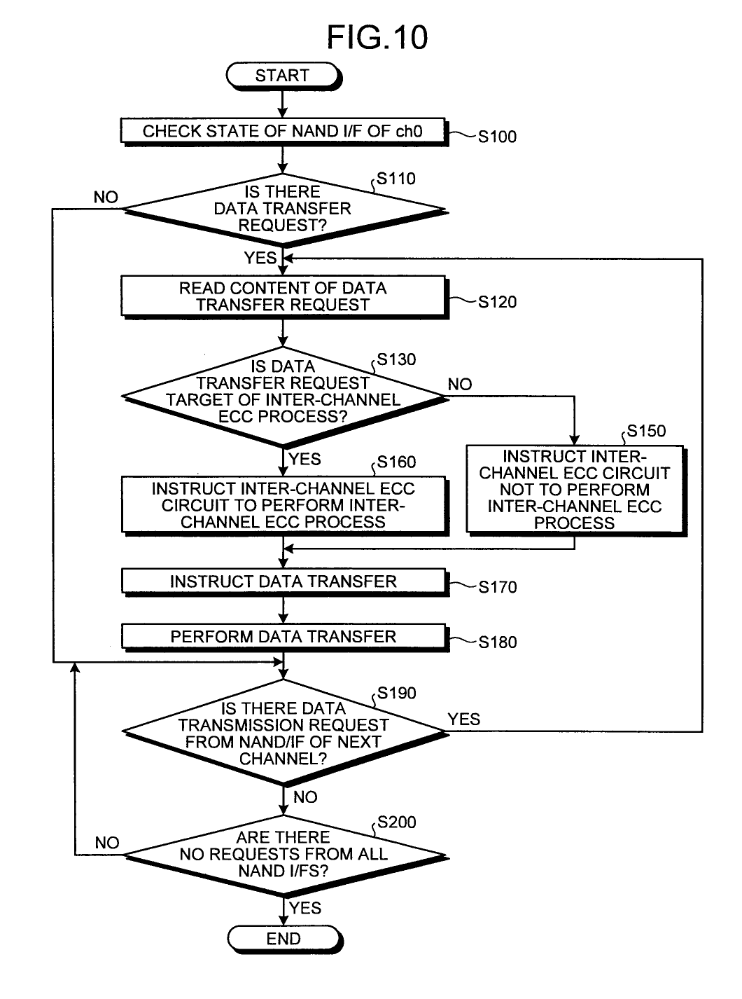

FIG. 10 is a flowchart illustrating an operation process of the transfer order management unit 23 according to the second embodiment. The flowchart illustrated in FIG. 10 does not include step S140 in the operation process illustrated in FIG. 7.

First, the transfer order management unit 23 determines whether or not there is a data transfer request from the NAND I/F 40-0 of the channel ch0 (steps S100 and S110). When there is no data transfer request, the process proceeds to step S190. When there is the data transfer request, the content of the data transfer request is read (step S120), and it is determined whether or not the data transfer is the target of the inter-channel ECC process, the inter-channel ECC on/off information Eflag added to the data transfer request in the content that is read (step S130).

When it is determined that the data transfer request is not the target of the inter-channel ECC process, the transfer order management unit 23 instructs the inter-channel ECC circuit 50 not to execute the inter-channel ECC process (step S150) and notifies the NAND I/F 40-0 of the execution permission for the data transfer (step S170). Thus, the NAND I/F 40-0 performs the data transfer between the NAND I/F 40-0 and the temporary memory buffer 30 without performing the inter-channel ECC process (step S180). After the data transfer is finished, the transfer order management unit 23 determines whether or not there is a next data transfer request from the next NAND I/F 40-1 decided in the round-robin fashion (step S190).

Meanwhile, when it is determined in step S130 that the current data transfer request is the target of the inter-channel ECC process, the transfer order management unit 23 outputs an inter-channel ECC process execution instruction including identification information representing encoding or decoding to the inter-channel ECC circuit 50 (step S160) and notifies the NAND I/F 40-0 of the execution permission of the data transfer (step S170). Thus, the NAND I/F 40-0 performs data transfer between the NAND I/F 40-0 and the temporary memory buffer 30 while performing the inter-channel ECC process (step S180).

The transfer order management unit 23 determines whether or not there is a data transfer request from the next NAND I/F 40-1 (step S190). When there is the data transfer request from the NAND I/F 40-1, the data transfer request from the NAND I/F 40-1 is dealt with by executing the processes of steps S120 to S180 in the aforementioned way. When there is no data transfer request from the NAND I/F 40-1, the transfer order management unit 23 determines whether or not there are requests from all of the NAND I/Fs (step S200). When there are requests from other NAND I/Fs, the aforementioned process is executed on the data transfer requests from the NAND I/Fs 40-2 and 40-3. When the process on the data transfer request from the NAND I/F 40-3 is finished, the aforementioned process is executed on the NAND I/F 40-0 again. In this way, when there are no data transfer requests from any of the NAND I/Fs 40, the transfer order management unit 23 finishes the process.

As described above, according to the second embodiment, the inter-channel ECC process is executed using data that is being transferred between the temporary memory buffer 30 and the NAND I/F 40, and it is determined whether or not the inter-channel ECC process is necessary. When the inter-channel ECC process is not necessary, the inter-channel ECC process is skipped. Therefore, the throughput and the system performance can be improved without reducing the band width of the temporary memory buffer.

### Third Embodiment

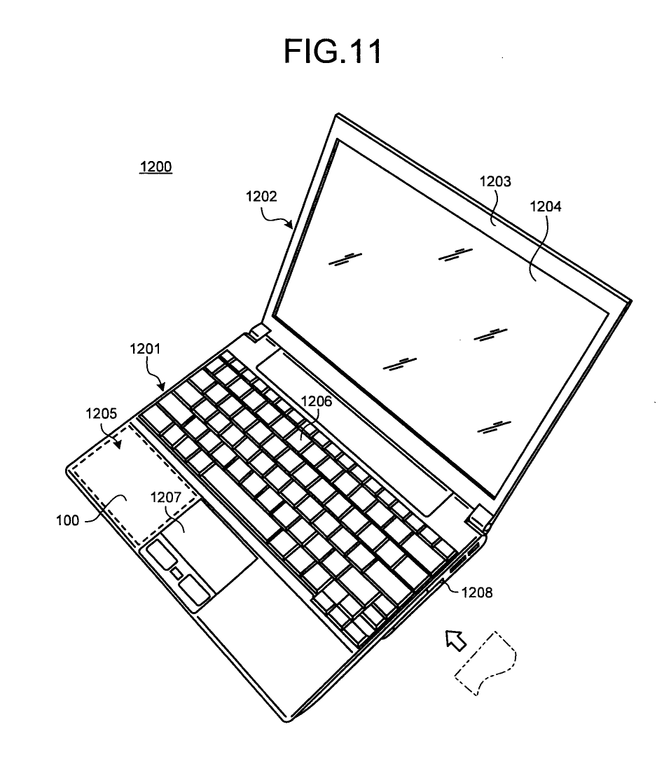

FIG. 11 is a perspective view of an example of a PC 1200 on which the SSD 100 is mounted. The PC 1200 includes a main body 1201 and a display unit 1202. The display unit 1202 includes a display housing 1203 and a display device 1204 accommodated in the display housing 1203.

The main body 1201 includes a chassis 1205, a keyboard 1206, and a touch pad 1207 as a pointing device. The chassis 1205 includes therein a main circuit board, an ODD (Optical Disk Device) unit, a card slot, the SSD 100, and the like.

The card slot is provided so as to be adjacent to the peripheral wall of the chassis 1205. The peripheral wall has an opening 1208 facing the card slot. A user can insert and remove an additional device into and from the card slot from outside the chassis 1205 through this opening 1208.

The SSD 100 may be used instead of a conventional HDD in the state of being mounted on the PC 1200 or may be used as an additional device in the state of being inserted into the card slot provided in the PC 1200.

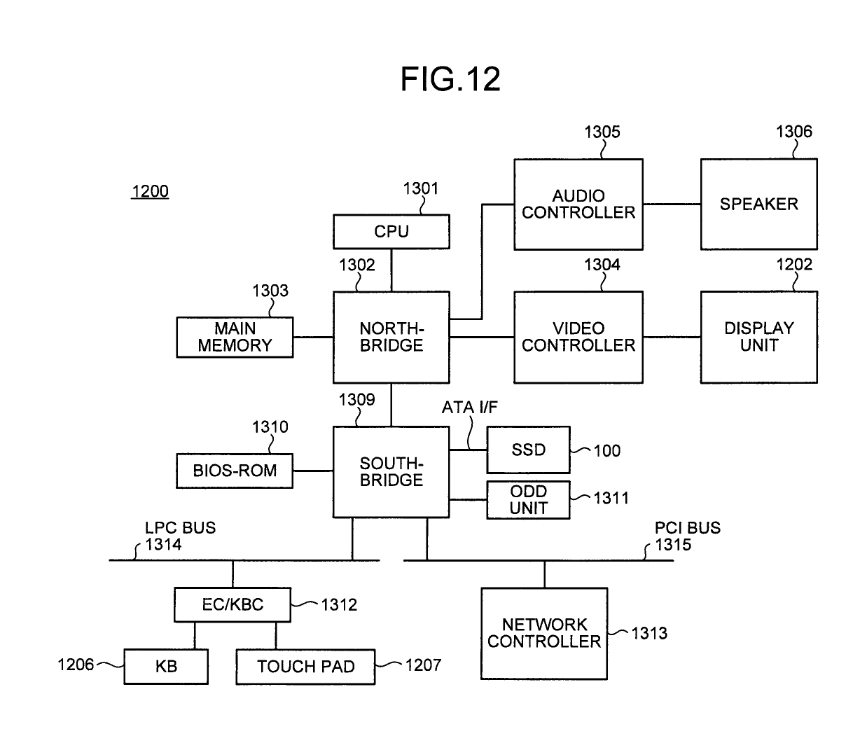

FIG. 12 illustrates a system configuration example of the PC on which the SSD is mounted. The PC 1200 includes a CPU 1301, a north bridge 1302, a main memory 1303, a video controller 1304, an audio controller 1305, a south bridge 1309, a BIOS-ROM 1310, the SSD 100, an ODD unit 1311, an embedded controller/keyboard controller IC (EC/KBC) 1312, a network controller 1313, and the like.

The CPU 1301 is a processor provided for controlling an operation of the PC 1200, and executes an operating system (OS) loaded from the SSD 100 onto the main memory 1303. Furthermore, when the ODD unit 1311 is capable of executing at least one of read processing and write processing on a mounted optical disk, the CPU 1301 executes the processing.

Moreover, the CPU 1301 executes a system BIOS (Basic Input Output System) stored in the BIOS-ROM 1310. The system BIOS is a program for controlling a hardware in the PC 1200.

The north bridge 1302 is a bridge device that connects a local bus of the CPU 1301 to the south bridge 1309. The north bridge 1302 has a memory controller for controlling an access to the main memory 1303.

Moreover, the north bridge 1302 has a function of executing a communication with the video controller 1304 and a communication with the audio controller 1305 through an AGP (Accelerated Graphics Port) bus or the like.

The main memory 1303 temporarily stores therein a program and data, and functions as a work area of the CPU 1301. The main memory 1303, for example, consists of a DRAM.

The video controller 1304 is a video reproduction controller for controlling the display unit 1202 used as a display monitor of the PC 1200.

The audio controller 1305 is an audio reproduction controller for controlling a speaker 1306 of the PC 1200.

The south bridge 1309 controls each device on an LPC (Low Pin Count) bus 1314 and each device on a PCI (Peripheral Component Interconnect) bus 1315. Moreover, the south bridge 1309 controls the SSD 100 that is a memory device storing various types of software and data through the ATA interface.

The PC 1200 accesses the SSD 100 in sector units. A write command, a read command, a cache flush command, and the like are input to the SSD 100 through the ATA interface.

The south bridge 1309 has a function of controlling an access to the BIOS-ROM 1310 and the ODD unit 1311.

The EC/KBC 1312 is a one-chip microcomputer in which an embedded controller for power management and a keyboard controller for controlling the keyboard (KB) 1206 and the touch pad 1207 are integrated.

This EC/KBC 1312 has a function of turning on/off the PC 1200 based on an operation of a power button by a user. The network controller 1313 is, for example, a communication device that executes communication with an external network such as the Internet.

### [Modification]

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the above-described embodiments, as the page ECC performed by the ECC circuit 43, the ECC code is added to data in page units. However, the ECC code may be added in units (for example, units of 512-byte sectors) where the unit is smaller than a page. In this configuration, when it is difficult to correct an error of data in units smaller than pages, it may be recognized that an error has occurred in the data, and the data may be recovered using the inter-channel ECC process configured with a plurality of channels. Further, in the ECC process performed by the ECC circuit 43, the ECC code may be added in units that are larger than pages but smaller than blocks.

In the above-described embodiments, a byte is used as a unit in which the inter-channel ECC is configured with a plurality of channels, but the invention is not limited thereto. The size larger or smaller than a byte may be used as the unit.

In the above-described embodiments, in the inter-channel ECC process, the number of channels in which data is written is 4, the number of channels in which redundant information of the data is written is 1, and the number of channels configuring the error correcting code is 5. However, the invention is not limited thereto. A channel for writing the redundant information of the inter-channel ECC process is fixed to the channel ch4, but the invention is not limited thereto. The channels may change for each unit configuring the ECC.

In the above-described embodiments, the channel is in a one-to-one correspondence relation with the NAND memory chip, but the invention is not limited thereto. One channel may be associated with a plurality of NAND memory chips. That is, a plurality of NAND memory chips may be allocated to one channel.

In the above-described embodiments, when a channel is allocated to writing target data, if a state in which there is no writing target data for a predetermined time period or more after at least one of the channels ch0 to ch3 is allocated, dummy data (for example, data in which all bits are “0”) is written in a corresponding page of a channel to which the writing target data is not allocated among the channels ch0 to ch3, and the redundant information calculated using data of each of corresponding pages of the channels ch0 to ch3 is written in a corresponding page of the channel ch4. According to this configuration, it is possible to avoid a possibility that the ECC is not configured on data of a channel on which writing has been already completed among corresponding pages of the channel ch0 to ch3 so that it is difficult to recover the data when an error occurs in the data.

1. A semiconductor storage device, comprising:
a non-volatile semiconductor memory including a plurality of memory areas which can be independently operated respectively;
a plurality of memory interfaces that execute an access to data in the plurality of memory areas and output data transfer requests;
a temporary memory buffer that temporarily stores data;
a transfer management unit that manages a data transfer order between the temporary memory buffer and the plurality of memory interfaces, based on the contents of the data transfer requests from the plurality of memory interfaces;
an error correction processing unit that executes encoding process related data to be dispersedly written over the plurality of memory areas and decoding process related data dispersedly written over the plurality of memory areas, using data that is being transferred between the temporary memory buffer and the plurality of memory interfaces; and
a control unit that controls the plurality of memory interfaces such that data and an encoding result of the error correction process are dispersedly written over the plurality of memory areas, and
wherein the transfer management unit determines whether or not data related to the data transfer request is a target of the error correction process and causes the error correction processing unit to execute the error correction process only with respect to the data determined as the target of the error correction process.

2. The semiconductor storage device according to claim 1,
wherein the transfer management unit has a function of managing an order of the data transfer requests from the plurality of memory interfaces, and
the transfer management unit checks the contents of the data transfer requests from the memory interfaces in order that the data transfer requests are input from the plurality of memory interfaces, and controls the permission of data transfer and the error correction process on the basis of the check result.

3. The semiconductor storage device according to claim 1,
wherein the transfer management unit has a function of checking the contents of the data transfer requests from the memory interfaces in predetermined order, and
the transfer management unit checks the contents of the data transfer requests from the memory interfaces in the predetermined order and controls the permission of data transfer and the error correction process on the basis of the check result.

4. The semiconductor storage device according to claim 1,
wherein the error correction processing unit employs an error correction system that executes the error correction process in a predetermined data order, and
the transfer management unit determines whether or not the data transfer request is a target of the error correction process and determines whether the order of the data transfer matches the data order, based on the contents of the data transfer requests from the memory interfaces,
when the order of the data transfer matches the data order, the transfer management unit causes the error correction processing unit to execute the error correction process and immediately executes the data transfer, and
when the order of the data transfer does not match the data order, the transfer management unit skips the data transfer and checks the content of the data transfer request from another memory interface.

5. The semiconductor storage device according to claim 1,
wherein the transfer management unit determines whether or not the data transfer request is a target of the error correction process and determines whether or not the order of the data transfer matches the data order, based on the contents of the data transfer requests from the memory interfaces, and
when it is determined that the data transfer request is not the target of the error correction process, the transfer management unit immediately executes the data transfer request without causing the error correction processing unit to execute the error correction process.

6. The semiconductor storage device according to claim 1,
wherein the error correction processing unit employs an error correction system that does not have a restriction that the error correction process is executed in a predetermined data order,
the transfer management unit determines whether or not the data transfer request is a target of the error correction process, based on the contents of the data transfer requests from the memory interfaces, and
the transfer management unit causes the error correction processing unit to execute the error correction process according to a result of the determination and immediately executes the data transfer.

7. The semiconductor storage device according to claim 1,
wherein the error correction processing unit employs an error correction system in which a data input order for decoding is decided depending on a data input order for encoding, and
the transfer management unit determines whether or not the data transfer request is a target of the error correction process and determines whether the error correction process is decoding or encoding, based on the contents of the data transfer requests from the memory interfaces, and
when it is determined that the error correction process is encoding, the transfer management unit causes the error correction processing unit to execute the error correction process so that the data transfer is immediately executed, and records an order of encoded data.

8. The semiconductor storage device according to claim 7,
wherein the transfer management unit determines whether or not the data transfer request is a target of the error correction process and determines whether the error correction process is decoding or encoding, based on the contents of the data transfer requests from the memory interfaces,
when it is determined that the error correction process is decoding, the transfer management unit further determines whether or not a decoding order matches, based on the order of encoded data recorded at the time of encoding,
when the decoding order matches, the transfer management unit causes the error correction processing unit to execute the error correction process so that the data transfer is immediately executed,
when the decoding order does not match, the transfer management unit skips the data transfer and checks the content of the data transfer request from another memory interface.

9. The semiconductor storage device according to claim 1,
wherein the error correction system used by the error correction processing unit is a cyclic code.

10. The semiconductor storage device according to claim 1,
wherein the error correction system used by the error correction processing unit calculates a parity based on an exclusive OR.

11. The semiconductor storage device according to claim 1,
wherein each of the plurality of memory areas includes one or more memory chips having a plurality of blocks, each block including a plurality of pages.

12. A control method of a semiconductor storage device that includes a non-volatile semiconductor memory including a plurality of memory areas which can be independently operated respectively, a plurality of memory interfaces that execute an access to data in the plurality of memory areas and output data transfer requests, and a temporary memory buffer that temporarily stores data, the method comprising:
managing data transfer order between the temporary memory buffer and the plurality of memory interfaces, based on the contents of the data transfer requests from the plurality of memory interfaces;
executing encoding process related data to be dispersedly written over the plurality of memory areas and decoding process related data dispersedly written over the plurality of memory areas, using data that is being transferred between the temporary memory buffer and the plurality of memory interfaces;
controlling the plurality of memory interfaces such that data and an encoding result of the error correction process are dispersedly written over the plurality of memory areas; and
determining whether or not data related to the data transfer request is a target of the error correction process and executing the error correction process only with respect to the data determined as the target of the error correction process.

13. A control method according to claim 12, the method further comprising:
managing, in the managing of data transfer order, an order of the data transfer requests from the plurality of memory interfaces, and
checking the contents of the data transfer requests from the memory interfaces in order that the data transfer requests are input from the plurality of memory interfaces, and controlling the permission of data transfer and the error correction process on the basis of the check result.

14. A control method according to claim 12, the method further comprising:
checking the contents of the data transfer requests from the memory interfaces in predetermined order and controlling the permission of data transfer and the error correction process on the basis of the check result.

15. A control method according to claim 12, the method further comprising:
employing, in the executing of encoding process, an error correction system that executes the error correction process in a predetermined data order, and
determining whether or not the data transfer request is a target of the error correction process and determining whether the order of the data transfer matches the data order, based on the contents of the data transfer requests from the memory interfaces,
executing, when the order of the data transfer matches the data order, the error correction process, and immediately executing the data transfer, and
skipping, when the order of the data transfer does not match the data order, the data transfer and checking the content of the data transfer request from another memory interface.

16. A control method according to claim 12, the method further comprising:
determining whether or not the data transfer request is a target of the error correction process and determining whether or not the order of the data transfer matches the data order, based on the contents of the data transfer requests from the memory interfaces, and
immediately executing, when it is determined that the data transfer request is not the target of the error correction process, the data transfer request without executing the error correction process.

17. A control method according to claim 12, the method further comprising:
employing, in the executing of encoding process, an error correction system that does not have a restriction that the error correction process is executed in a predetermined data order,
determining whether or not the data transfer request is a target of the error correction process, based on the contents of the data transfer requests from the memory interfaces, and
executing the error correction process according to a result of the determination and immediately executing the data transfer.

18. A control method according to claim 12, the method further comprising:
employing, in the executing of encoding process, an error correction system in which a data input order for decoding is decided depending on a data input order for encoding, and
determining whether or not the data transfer request is a target of the error correction process and determining whether the error correction process is decoding or encoding, based on the contents of the data transfer requests from the memory interfaces, and
executing, when it is determined that the error correction process is encoding, the error correction process so that the data transfer is immediately executed, and recording an order of encoded data.

19. A control method according to claim 18, the method further comprising:
determining whether or not the data transfer request is a target of the error correction process and determining whether the error correction process is decoding or encoding, based on the contents of the data transfer requests from the memory interfaces,
determining when it is determined that the error correction process is decoding, whether or not a decoding order matches, based on the order of encoded data recorded at the time of encoding,
executing, when the decoding order matches, the error correction process so that the data transfer is immediately executed,
skipping, when the decoding order does not match, the data transfer and checking the content of the data transfer request from another memory interface.

20. A control method according to claim 12, wherein
the error correction system used in the executing of encoding process is a cyclic code.

21. A control method according to claim 12, wherein
the error correction system used in the executing of encoding process calculates a parity based on an exclusive OR.

22. A control method according to claim 12, wherein
each of the plurality of memory areas includes one or more memory chips having a plurality of blocks, each block including a plurality of pages.
